(19) United States
(12) Patent Application Publication
(10) Pub. No.: US 2025/0377471 A1
(43) Pub. Date: Dec. 11, 2025

(54) METHOD AND DEVICE FOR VELOCITY TOMOGRAPHY IMAGING OF SEABED SHALLOW MEDIA AND ELECTRONIC EQUIPMENT

(71) Applicants: CHINA UNIVERSITY OF GEOSCIENCES (BEIJING), Beijing (CN); DataStreams Corp., Beijing (CN)

(72) Inventors: Yun WANG, Beijing (CN); Yi ZHANG, Beijing (CN)

(21) Appl. No.: 18/934,612

(22) Filed: Nov. 1, 2024

(30) Foreign Application Priority Data
Jun. 5, 2024 (CN) 2024107260253

(51) Int. Cl. G01V 1/30; G01V 1/28

(52) U.S. Cl. CPC G01V 1/303; G01V 1/282

(57) ABSTRACT

The disclosure provides a method and device for velocity tomography imaging of seabed shallow media, and electronic equipment. The method includes performing multichannel analyses of Guided-P and Scholte waves on seabed multi-component seismic gathers to determine measured multi-order dispersion curves of the two waves; based on a first seabed shallow media model and a theoretical dispersion equation of Guided-P wave, performing joint inversion of multi-order dispersion curves of Guided-P wave to iteratively update the P-wave velocity of seabed media; based on a second seabed shallow media model and a theoretical dispersion equation of Scholte wave, performing joint inversion of multi-order dispersion curves of Scholte wave to iteratively update the S-wave velocity of seabed media under the constraint of the P-wave velocity determined by the Guided-P wave dispersion inversion; and performing tomography imaging of seabed velocity structures with the inverted P-wave and S-wave velocities along a survey line.

### CROSS REFERENCE TO RELATED APPLICATIONS

This application is based upon and claims priority to Chinese Patent Application No. 202410726025.3, filed on Jun. 5, 2024, the entire contents of which are incorporated herein by reference.

### TECHNICAL FIELD

The disclosure relates to the field of marine seismic exploration, in particular to a method and device, for velocity tomography imaging of shallow seabed media, and electronic equipment.

### BACKGROUND

In shallow marine environment, the pressure excited by air-gun source can induce the generation and propagation of Guided-P wave and fluid-solid interface wave (i.e., Scholte wave). The two waves exhibit the dispersion characteristics that are sensitive to the changes in P-wave and S-wave velocities of seabed shallow media, respectively. Therefore, a comprehensive tomographic prediction of the velocity structures of subsurface layers from tens to several hundreds of meters below the seabed interface can be achieved via the dispersion inversions of Guided-P and Scholte waves.

The velocities of seismic wave propagating in seabed shallow media are closely associated to the elastic modulus that can govern the strain strength and stiffness of media, and thus the seabed shallow velocity structures are highly valuable in many applications. For instance, based on the structures of P-wave and S-wave velocities and Vp/Vs ratios, the elastic modulus, mechanical properties and site-effects of seabed shallow media can be estimated under the condition that the media densities are known, thereby providing the crucial parameters for the design and stability assessment of foundations for ocean engineering activities, such as drilling platforms, wind farm constructions, subsea pipeline and tunnels, and cross-sea bridges. Furthermore, accurately determining the P-wave and S-wave velocities and their ratios of seabed shallow media can provide the reliable shallow velocity models for marine seismic data processing, including the static correction, P-S wave-filed separation and multiple wave attenuation in the water layer.

Since Scholte wave was discovered, numerous scholars have studied a vary of dispersion inversion techniques related to it, and performed the Vs structure tomography imaging of seabed shallow media based on the dispersion inversions of field Scholte wave seismic data acquired in various sea regions, which can provide crucial references for marine geology investigations and seismic explorations. However, these works are limited to retrieving seabed S-wave velocity, because the dispersion curves of Scholte wave exhibit extreme insensitivity to the change in P-wave velocity. Besides, most of the existing studies on Guided-P and Scholte waves are mainly carried out on a single vertical component. This approach may lead to the misjudgment of dispersion modes and the lack of constraints from abundant higher-order dispersion curves during dispersion inversion, resulting in a lower inversion accuracy. The above problems will cause large errors in the tomography imaging of velocity structures of seabed shallow media.

### SUMMARY

In a first aspect, provided is a method for P-wave and S-wave velocity tomography imaging of seabed shallow media using Guided-P and Scholte waves on multi-component, including: performing multichannel dispersion analyses of Guided-P and Scholte waves on seabed multi-component seismic gathers to determine measured multi-order dispersion curves of Guided-P and Scholte waves within corresponding frequency and velocity ranges; performing, based on a first seabed shallow media model for Guided-P wave dispersion inversion and a theoretical dispersion equation of Guided-P wave, joint inversion of the measured multi-order dispersion curves of Guided-P wave to iteratively update a model P-wave velocity, until a relative difference between measured and theoretical multi-order dispersion curves of Guided-P wave meets a first termination condition; performing, based on a second seabed shallow media model for Scholte wave dispersion inversion and a theoretical dispersion equation of Scholte wave, joint inversion of measured multi-order dispersion curves of Scholte wave to iteratively update a model S-wave velocity under the constraint of the P-wave velocity determined by Guided-P wave dispersion inversion, until a relative difference between measured and theoretical multi-order dispersion curves of Scholte wave meets a second termination condition; and performing, based on the P-wave and S-wave velocities respectively determined by Guided-P and Scholte wave dispersion inversions, tomography imaging of velocity structures for seabed shallow media.

In a second aspect, provided is a device for velocity tomography imaging of seabed shallow media, including: a dispersion analysis module, i.e., configured to perform multichannel dispersion analyses of Guided-P and Scholte waves on seabed multi-component seismic gathers to determine measured multi-order dispersion curves of Guided-P and Scholte waves within corresponding frequency and velocity ranges; a first dispersion inversion module, configured to perform, based on a first seabed shallow media model for Guided-P wave dispersion inversion and a theoretical dispersion equation of Guided-P wave, joint inversion of the measured multi-order dispersion curves of Guided-P wave to iteratively update a model P-wave velocity, until a relative difference between measured and theoretical multi-order dispersion curves of Guided-P wave meets a first termination condition; a second dispersion inversion module, configured to perform, based on a second seabed shallow media model for Scholte wave dispersion inversion and a theoretical dispersion equation of Scholte wave, joint inversion of measured multi-order dispersion curves of Scholte wave to iteratively update a model S-wave velocity under the constraint of the P-wave velocity determined by Guided-P wave dispersion inversion, until a relative difference between measured and theoretical multi-order dispersion curves of Scholte wave meets a second termination condition; and a tomography imaging module, configured to perform, based on the P-wave and S-wave velocities respectively determined by Guided-P and Scholte wave dispersion inversions, tomography imaging of velocity structures for the seabed shallow media.

In a third aspect, provided is an electronic equipment including a processor and a memory arranged to store computer executable instructions. The executable instructions, when executed, cause the processor to perform the method as described in the first aspect.

In a fourth aspect, provided is a computer program product including a non-transitory computer-readable storage medium storing a computer program, wherein the computer program is operable to cause a computer to perform the method as described in the first aspect.

### BRIEF DESCRIPTION OF THE DRAWINGS

The patent file contains at least one drawing executed in color. Copies of this patent or patent application publication with color drawing(s) will be provided by the Office upon request and payment of the necessary fee.

In order to more clearly illustrate the technical solutions in the embodiments of the present disclosure or the prior art, the drawings that need to be used in the description of the embodiments or prior art will be briefly introduced therebelow. It is obvious that the drawings described below are merely examples of some embodiments described in the present disclosure, and for those skilled in the art, other drawings can be obtained from these drawings without making creative effort.

FIG. 1 is a first flow diagram of a method for velocity tomographic imaging of seabed shallow media according to an embodiment of the present disclosure.

FIG. 2 is a second flow diagram of a method for velocity tomographic imaging of seabed shallow media according to an embodiment of the present disclosure.

FIG. 3 is a schematic diagram of a horizontal layered seabed media model.

FIG. 4 is a schematic diagram of synthetic three-component (3C) Guided-P and Scholte wave seismic records.

FIG. 5 is a schematic diagram of the dispersion images in the frequency-velocity (f-v) domain for the synthetic3C Guided-P and Scholte wave seismic records.

FIG. 6 is a schematic diagram of the dispersion inversion results of synthetic Guided-P and Scholte wave data.

FIG. 7 is a schematic diagram of the field 4C-OBN common receiver point seismic gathers.

FIG. 8 is a schematic diagram of the dispersion images of field Guided-P wave seismic records in the corresponding frequency and velocity ranges.

FIG. 9 is a schematic diagram of the dispersion images of field Scholte wave seismic records in the corresponding frequency and velocity ranges.

FIG. 10 is a schematic diagram of the dispersion inversion results of field Guided-P and Scholte wave data.

FIG. 11 is a schematic diagram of the 2D pseudo profile of P-wave and S-wave velocity structures of seabed shallow (50 m below seabed interface) media.

FIG. 12 is a schematic diagram of comparison of the dispersion inversion results for both Guided-P and Scholte waves using the two methods of the single-component fundamental mode inversion and the joint inversion of the fundamental and higher modes on multi-component.

FIG. 13 is a schematic diagram of the device for velocity tomography imaging of seabed shallow media in the embodiment of this disclosure.

FIG. 14 is a schematic diagram of the electronic equipment in the embodiment of this disclosure.

### DETAILED DESCRIPTION

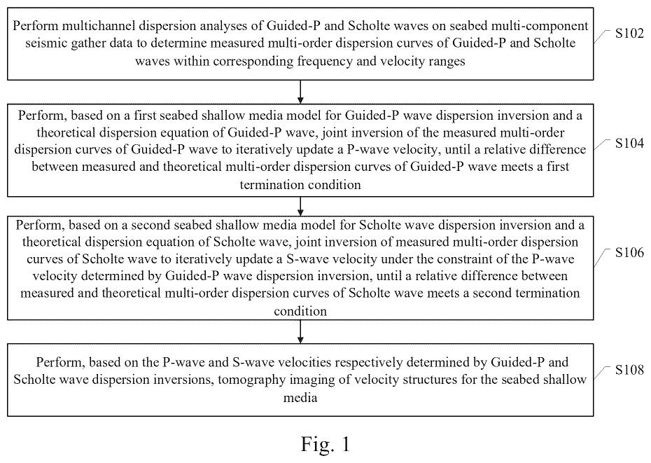

In order to enable those skilled in the art to better understand the technical solutions in the present specification, the technical solutions in the embodiments of the present application will be clearly and completely described below with reference to the accompanying drawings in the embodiments of the present disclosure, and it is obvious that the described embodiments are only a part of the embodiments of the present specification, but not all the embodiments. Based on the embodiments in this specification, all other embodiments obtained by those skilled in the art without creative work should fall within the scope of protection of this specification. One embodiment of the present disclosure proposes a method for velocity tomography imaging of seabed shallow media. Where, FIG. 1 shows a flow diagram of the tomography imaging method, including steps S102 to S108.

At S102: multichannel dispersion analyses of Guided-P and Scholte waves are performed on multi-component seismic gathers to determine measured multi-order dispersion curves of Guided-P and Scholte waves within the corresponding frequency and velocity ranges.

The multi-component described in this embodiment includes the horizontal (R), vertical (Z) and pressure (P) components. The multi-order dispersion curves include, but not limited to, the fundamental and higher-mode dispersion curves.

According to the embodiment, the multi-component stacking dispersion images of Guided-P and Scholte wave can be generated in the corresponding frequency and velocity ranges though the multichannel dispersion analyses on the seabed seismic gathers on multi-component. The stacking dispersion images can make the dispersion energy of various modes on each single-component appearing in the same image. After that, the dispersion points corresponding to the maximum in the stacking dispersion images are picked up to yield the measured dispersion curves. According to the wave type and the order of dispersion modes, the measured dispersion curves of the two waves are output and saved.

At S104: Based on a first seabed shallow media model for Guided-P wave dispersion inversion and a theoretical dispersion equation of Guided-P wave, joint inversion of the measured multi-order dispersion curves of Guided-P wave is performed to iteratively update the model P-wave velocity, until the relative difference between measured and theoretical multi-order dispersion curves of Guided-P wave meets a first termination condition.

In one feasible implementation of this step: firstly, the first seabed shallow media model for the Guided-P wave dispersion inversion is constructed based on the half-wavelength theory and empirical formulas of seabed shallow media. This model consists of multiple equi-thickness thin layers and a semi-infinite space beneath them. The maximum total depth of model is determined by the maximum phase velocity and minimum frequency in the measured multi-mode dispersion curves of P-waves. The initial P-wave velocity and density of each layer are determined by the empirical formulas, and the density values remain constant during the iterative calculations for Guided-P wave dispersion inversion.

Then, based on physical parameters (including P-wave velocity, thickness and density) of each the equi-thickness thin layer and the semi-infinite space of the first seabed shallow media model, the theoretical multi-order dispersion curves of Guided-P wave phase velocities for this model are calculated by solving the theoretical dispersion equation of Guided-P wave.

Subsequently, based on a first objective function, the corrected values of the P-wave velocities for each the equi-thickness thin layer and the semi-infinite space in the first seabed shallow media model are iteratively calculated, and the P-wave velocity of each layer is adjusted according to the corrected values obtained from each iteration.

Where, the first objective function is expressed as:

$${Φ}_{P} = {‖ {J}_{P} Δ {V}_{P} - Δ {b}_{P} ‖}_{2}^{2} W {‖ {J}_{P} Δ {V}_{P} - Δ {b}_{P} ‖}_{2} + α {‖ Δ {V}_{P} ‖}_{2}^{2} ,$$

Where J_{P} denotes the Jacobi matrix composed of the first-order partial derivatives of Guided-P wave phase velocity to P-wave velocity, ΔVp denotes the corrected values of P-wave velocity, Δbₚ denotes the relative difference between the measured and theoretical multi-order dispersion curves of Guided-P wave, α denotes the damping coefficient, and W denotes the weighting matrix.

The element of Jacobi matrix is the first-order partial derivatives of Guided-P wave phase velocity (cₚ) to P-wave velocity, which can be expressed as follows:

$${J}_{P} = [ - \frac{\partial {F}_{P} / \partial {V}_{Pi}}{\partial {F}_{P} / \partial {c}_{p}} \vert f = {f}_{j} ]$$

Where, Fp (fj, cpj, Vp, ρ, h), j=1, 2, . . . m denotes the secular function of Guided-P wave, which is a highly nonlinear implicit function determined by the dispersion equation, Vp=[Vp1, Vp2, . . . , Vpn] denotes the P-wave velocity vector, ρ=[ρ1, ρ2, . . . , ρn] denotes the density vector, h=[h1, h2, . . . , hn−1] denotes the thickness vector.

It should be understood that the iterative calculation of the first objective function can be terminated when the relative difference between the measured and theoretical multi-order dispersion curves of Guided-P wave is less than or equal to a first allowable error tolerance, thereby determining the final adopted P-wave velocities of seabed shallow media.

It should be noted that the method for quantifying the relative difference between the measured and theoretical multi-order dispersion curves of Guided-P wave is not specified in this embodiment. As an illustrative example, the formula for calculating the relative difference between the measured and theoretical multi-order dispersion curves of Guided-P wave can be expressed as:

$$rms ( dvp ) = \sqrt{1 / {N}_{1} {\sum }_{i = 1}^{{N}_{1}} {( \frac{Δ {b}_{Pi}}{{b}_{pi}^{obs}} )}^{2}}$$

where N₁ denotes the total of multi-order dispersion points for Guided-P wave.

At S106: Based on a second seabed shallow media model or Scholte wave dispersion inversion and a theoretical dispersion equation of Scholte wave, joint inversion of measured multi-order dispersion curves of Scholte wave is performed to iteratively update a model S-wave velocity under the constraint of the P-wave velocity determined by the Guided-P wave dispersion inversion, until the relative difference between the measured and theoretical multi-order dispersion curves of Scholte wave meets a second termination condition.

In one feasible implementation of this step: firstly, the second seabed shallow media model for the Scholte wave dispersion inversion is constructed based on the half-wavelength theory and empirical formulas of seabed shallow media. Where, the second seabed shallow media model comprises multiple equi-thickness thin layers and a semi-infinite space that are identical to those in the first seabed shallow media model. Each the equi-thickness thin layer adopts the P-wave velocity for this model determined by Guided-P wave dispersion inversion and remains fixed, the initial S-wave velocity of each solid layer is determined by the P-wave velocity and the empirical Vp/Vs ratio of seabed shallow media, and the thickness and density parameters are consistent with those in the first seabed shallow media model respectively.

Then, based on physical parameters of each the equi-thickness thin layer and semi-infinite space (including P-wave velocity, S-wave velocity, thickness and density) in the second seabed shallow media model, the theoretical multi-order dispersion curves of Scholte wave phase velocities for this model are calculated by solving the theoretical dispersion equation of Scholte wave. Where, the way of obtaining the theoretical dispersion equation of Scholte wave can refer to the way of obtaining the theoretical dispersion equation of Guided-p wave, which is not repeated herein.

Subsequently, based on a second objective function, the corrected values of the S-wave velocities for each equi-thickness thin layers (alternatively, also the semi-infinite space) in the second seabed shallow media model are iteratively calculated, and the S-wave velocity of each layer is adjusted according to the corrected values obtained from each iteration.

Where, the second objective function is expressed as:

$${Φ}_{S} = {‖ {J}_{S} Δ {V}_{S} - Δ {b}_{S} ‖}_{2}^{2} W {‖ {J}_{S} Δ {V}_{S} - Δ {b}_{S} ‖}_{2} + α {‖ Δ {V}_{S} ‖}_{2}^{2}$$

where J_{S} denotes the Jacobi matrix composed of the first-order partial derivatives of Scholte wave phase velocity to S-wave velocity, ΔVs denotes the corrected values of S-wave velocity, Δbₛ denotes the relative difference between the measured and theoretical multi-order dispersion curves of Scholte wave.

The element of Jacobi matrix is the first-order partial derivatives of Scholte wave phase velocity (cₛ) to S-wave velocity, which can be expressed as follows:

$${J}_{S} = [ - \frac{\partial {F}_{S} / \partial {V}_{Si}}{\partial {F}_{S} / \partial {c}_{S}} \vert f = {f}_{j} ]$$

where F_{S}(fⱼ, csⱼ, Vp, Vs, ρ, h), j=1, 2, . . . m denotes the secular function of Scholte wave, which is also a highly nonlinear implicit function determined by the fluid-solid interface wave dispersion equation, Vs=[Vs₁, Vs₂, . . . , Vsₙ] denotes the S-wave velocity vector.

Similarly, the iterative calculation of the second objective function can be terminated when the relative difference between the measured and theoretical multi-order dispersion curves of Scholte wave is less than or equal to the second allowable error tolerance, thereby determining the final adopted S-wave velocities of seabed shallow media.

It should be noted that the method for quantifying the relative difference between the measured and theoretical multi-order dispersion curves of Scholte wave is not specified in this embodiment. As an illustrative example, the formula for calculating the relative difference between the measured and theoretical multi-order dispersion curves of Scholte wave can be expressed as:

$$rms ( dvp ) = \sqrt{1 / {N}_{2} {\sum }_{i = 1}^{{N}_{2}} {( \frac{Δ {b}_{Si}}{{b}_{Si}^{obs}} )}^{2}}$$

At S108: Based on the P-wave and S-wave velocities respectively determined by Guided-P and Scholte wave dispersion inversions, tomography imaging of velocity structures for seabed shallow media is performed.

According to this embodiment, 2D tomography imaging of P-wave and S-wave velocity structures for seabed shallow media is performed based on the 1D Vp and Vs profiles at different lateral positions inverted by the various Guided-P and Scholte wave seismic gathers along the survey lines.

In summary, the method in this embodiment has two advantages over the traditional single-component surface wave technique as follows. Firstly, comprehensive determinations of the P-wave and S-wave velocities as well as Vp/Vs ratio of seabed shallow media is achieved by incorporating the dispersion inversions of Guided-P and Scholte waves. The P-wave velocity obtained from Guided-P wave dispersion inversion can provide the P-wave velocity and good constraints for the surface wave dispersion inversion; and secondly, model misjudgment can be effectively avoided and the accuracy of velocity inversion is improved by fully using the multimodal dispersion information of the two waves on multi-component. Ultimately, this approach enables the comprehensive and high-resolution tomographic imaging of velocity structures of seabed shallow media, thereby providing crucial data support data for marine seismic data processing and foundation stability assessment of ocean engineering activities, such as drilling platforms, wind farm constructions, subsea pipeline and tunnels, and cross-sea bridges. Hereinafter, the method of the present embodiment will be described in detail.

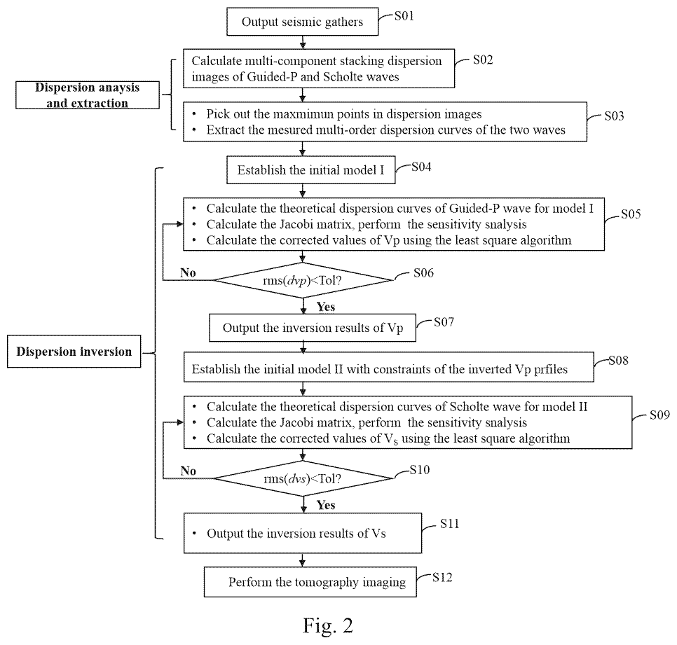

As illustrated in FIG. 2, the workflow of the method in this embodiment includes the following steps S01 to S12.

At S01: multi-component seabed seismic gathers are input to perform the multichannel dispersion analyses of Guided-P and Scholte waves thereon.

At S02: the multi-component stacking dispersion images of Guided-P and Scholte wave are generated in the corresponding frequency and velocity ranges, making dispersion energy of various modes on each single-component appear in the same image. The multi-component stacking dispersion image and each single-component dispersion image are combined to accurately determine the order of each dispersion mode.

S03: the measured dispersion curves are picked out, that is, the dispersion points (fᵢ, vᵢ) corresponding to the maximum energy values are manually or automatically picked out in the stacking dispersion images. Then, according to the wave type and the order of dispersion modes, the measured multimodal dispersion curves of Guided-P and Scholte waves are output and saved.

The above steps S02 to S03 pertain to dispersion analysis and extraction, the following steps are related to dispersion inversion.

At S04: the initial model I for the dispersion inversion of Guided-P wave is established by using the following strategies, 1) Based on the half-wavelength theory, the maximum detection depth and present the relationships between P-wave velocity and depth are calculated. A model consisting of numerous equi-thickness thin layers and one semi-infinite space is constructed according to this mathematical relationship, and the initial P-wave velocity is set for each layer accordingly. And 2) The initial density of each layer for model I is set based on the empirical formula:

$$ρ ( h ) = 310 \cdot {Vp ( h )}^{0.25}$$

where h denotes the vertical depth below seabed interface. In this implementation example, the setting of initial S-wave velocity is not involved in Guided-P wave dispersion inversion, which can reduce the influence of model parameter on inversion stability to a certain extent.

At S05: the dispersion inversion of Guided-P wave for the model I is performed. This section consists of the three parts as follows: 1) the theoretical dispersion curves of Guided-P wave based on model I is calculated, in which the involved Guided-P wave dispersion equation is an important content in this invention and will be detailed introduced in the following sections; 2) the Jacobi matrix, is calculated and the sensitivities of Guided-P wave dispersion curves to model parameters are analyzed; and 3) the efficient and stable damped least square algorithm are utilized to conduct the dispersion inversion of Guided-P wave and calculate the corrected values of model P-wave velocities. The object function (Φ_{P}) can be defined as:

$${Φ}_{P} = {‖ {J}_{P} Δ {V}_{P} - Δ {b}_{P} ‖}_{2}^{2} W {‖ {J}_{P} Δ {V}_{P} - Δ {b}_{P} ‖}_{2} + α {‖ Δ {V}_{P} ‖}_{2}^{2} , \qquad ( 1 )$$

where J_{P} denotes the Jacobi matrix composed of the first-order partial derivatives of Guided-P wave phase velocity to P-wave velocity, ΔVp denotes the corrected values of P-wave velocity, Δbₚ=bₚ^{obs}−bₚ denotes the difference between the measured and theoretical multi-order dispersion curves of Guided-P wave, α denotes the damping coefficient, which is adjusted during the iteration process based on the convergence or divergence of the objective function so as to improve the computational efficiency and stability of the inversion, and W denotes the weighting matrix.

At S06: The iteration calculation for Guided-P wave dispersion inversion is stopped as the first termination condition is met; otherwise, step S05 is continued. The first termination condition is that the root mean square (rms (dvp)) of the ratio of the difference between the measured and theoretical multi-order dispersion curves of Guided-P wave to the measured ones is less than the allowable error tolerance (Tol).

At S07: the inversion results of Vp that meet the error requirement is output.

At S08: the initial model II for the dispersion inversion of Scholte wave is established. Considering that Scholte wave generally exhibits a lower observable frequency range and weaker wave-field energy compared to Guided-P wave, the conditions for establishing the initial model in Scholte wave dispersion inversion should be as follows: 1) the number of layers and the thickness of each layer in model II should be consistent with or more refined than those in model I. And 2) the P-wave velocity of each layer is set by the Vp determined by the step S07, and the initial S-wave velocity is constrained by the P-wave velocity and set reasonably according to the the half-wavelength theory and empirical formulas of seabed shallow media.

At S09: the dispersion inversion of Scholte wave is performed based on the model II. This section consists of the three parts as follows: 1) the theoretical dispersion curves of Scholte wave based on model II is calculated. 2) the Jacobi matrix is calculated, and the sensitivities of Scholte wave dispersion curves to model parameters are analyzed. And 3) the damped least square algorithm is utilized to conduct the dispersion inversion of Scholte wave and calculate the corrected values of model S-wave velocities.

The object function (Φ_{S}) can be defined as:

$${Φ}_{S} = {‖ {J}_{S} Δ {V}_{S} - Δ {b}_{S} ‖}_{2}^{2} W {‖ {J}_{S} Δ {V}_{S} - Δ {b}_{S} ‖}_{2} + α {‖ Δ {V}_{S} ‖}_{2}^{2} , \qquad ( 2 )$$

where Js denotes the Jacobi matrix composed of the first-order partial derivatives of Scholte wave phase velocity to S-wave velocity, ΔVs denotes the corrected values of S-wave velocity, Δb_{S}=b_{S}^{obs}−b_{S} denotes the difference between the measured and theoretical multi-order dispersion curves of Scholte wave.

At S10: The iteration calculation for Scholte wave dispersion inversion is stopped as the second termination condition is met; otherwise, continue with step S09. The second termination condition is that the root mean square (rms (dvs)) of the ratio of the difference between the measured and theoretical multi-order dispersion curves of Scholte wave to the measured ones is less than the allowable error tolerance (Tol).

At S11: the inversion results of Vs that meet the error requirement is output, and the Vp/Vs ratio can be calculated by the available Vp and Vs.

At S12: the all 1D P-wave and S-wave velocities at different depths obtained from the dispersion inversions of various seismic gathers along survey lines are output. these values are arranged and interpolated according to their respective lateral positions to perform the tomography imaging of velocity structures for seabed shallow media.

The derivation of the dispersion equation of marine Guided-P wave involved in step S05 is as follows:

FIG. 3 depicts the schematic diagram of the horizontal layered seabed media model, in which the X-axis is parallel to the sea surface and positive to the right and the Z-axis is perpendicular to the sea surface and positive to the downward. As it shown, it is considered that the plane wave of horizontal phase velocity (c) propagated in a two-dimension (2D) model comprised of n+1 parallel, homogeneous and isotropic layers. The seawater layer is set as the 0^{th} layer, and the underlying ones are the seabed solid layers. Previous studies on establishing the dispersion equations of surface waves were carried out by the relationships between P- and S-wave potential functions and the displacement and stress components at the top and bottom interfaces of each layer, as well as the transitivity between the eigenvalues of adjacent layers. When placing the origin of the Z-axis at the top interface of the m^{th} layer, the constant coefficients (B′ₘ, B″ₘ, C′ₘ, C″ₘ) in potential functions and the top interface eigenvalues (uₘ₋₁, wₘ₋₁, σₘ₋₁, τₘ₋₁) as well as the bottom interface eigenvalues (uₘ, wₘ, σₘ, τₘ) have the following linear relationship as:

$$[ \begin{matrix}{u}_{m - 1} \\ {w}_{m - 1} \\ {σ}_{m - 1} \\ {τ}_{m - 1}\end{matrix} ] = {E}_{m} [ \begin{matrix}{B}_{m}^{′} + {B}_{m}^{″} \\ {B}_{m}^{′} - {B}_{m}^{″} \\ {C}_{m}^{′} - {C}_{m}^{″} \\ {C}_{m}^{′} + {C}_{m}^{″}\end{matrix} ] , [ \begin{matrix}{u}_{m} \\ {w}_{m} \\ {σ}_{m} \\ {τ}_{m}\end{matrix} ] = {D}_{m} [ \begin{matrix}{B}_{m}^{′} + {B}_{m}^{″} \\ {B}_{m}^{′} - {B}_{m}^{″} \\ {C}_{m}^{′} - {C}_{m}^{″} \\ {C}_{m}^{′} + {C}_{m}^{″}\end{matrix} ] ⇒ [ \begin{matrix}{u}_{m} \\ {w}_{m} \\ {σ}_{m} \\ {τ}_{m}\end{matrix} ] = {D}_{m} {{E}_{m}}^{- 1} [ \begin{matrix}{u}_{m - 1} \\ {w}_{m - 1} \\ {σ}_{m - 1} \\ {τ}_{m - 1}\end{matrix} ] , \qquad ( 3 )$$

where u and w denote the horizontal and vertical displacement components, respectively, σ and τ denote the normal and tangential stress components, respectively, the subscript of m indicates the mth layer, and two sets of constant coefficients

$$( {B}_{m}^{′} , {B}_{m}^{″} ) and ( {C}_{m}^{′} , {C}_{m}^{″} )$$

are related to the downward and upward wave-fields of P- and S-wave, respectively. The expressions of matrices of Em and Dm may be represented as follows:

$${E}_{m} = [ \begin{matrix}- {( {V}_{{P}_{m}} / c )}^{2} & 0 & - {γ}_{m} {r}_{{β}_{m}} & 0 \\ 0 & - {( {V}_{{P}_{m}} / c )}^{2} {r}_{{α}_{m}} & 0 & {γ}_{m} \\ - {ρ}_{m} {{V}_{{P}_{m}}}^{2} ( {γ}_{m} - 1 ) & 0 & - {ρ}_{m} {c}^{2} {γ}_{m} {r}_{{β}_{m}} & 0 \\ 0 & {ρ}_{m} {{V}_{{P}_{m}}}^{2} {γ}_{m} {r}_{{α}_{m}} & 0 & - {ρ}_{m} {c}^{2} {γ}_{m} ( {γ}_{m} - 1 )\end{matrix} ] , \qquad ( 4 )$$

$${D}_{m} = [ \begin{matrix}- {( {V}_{{P}_{m}} / c )}^{2} cos ( {P}_{m} ) & {i ( {V}_{{P}_{m}} / c )}^{2} sin ( {P}_{m} ) & - {γ}_{m} {r}_{{β}_{m}} cos ( {Q}_{m} ) & i {γ}_{m} {r}_{{β}_{m}} sin ( {Q}_{m} ) \\ {i ( {V}_{{P}_{m}} / c )}^{2} {r}_{{α}_{m}} sin ( {P}_{m} ) & - {( {V}_{{P}_{m}} / c )}^{2} {r}_{{α}_{m}} cos ( {P}_{m} ) & - i {γ}_{m} sin ( {Q}_{m} ) & {γ}_{m} cos ( {Q}_{m} ) \\ - {ρ}_{m} {{V}_{{P}_{m}}}^{2} ( {γ}_{m} - 1 ) cos ( {P}_{m} ) & i {ρ}_{m} {{V}_{{P}_{m}}}^{2} ( {γ}_{m} - 1 ) sin ( {P}_{m} ) & - {ρ}_{m} {c}^{2} {{γ}_{m}}^{2} {r}_{{β}_{m}} cos ( {Q}_{m} ) & i {ρ}_{m} {c}^{2} {{γ}_{m}}^{2} {r}_{{β}_{m}} sin ( {Q}_{m} ) \\ - i {ρ}_{m} {{V}_{{P}_{m}}}^{2} {γ}_{m} {r}_{{α}_{m}} sin ( {P}_{m} ) & {ρ}_{m} {{V}_{{P}_{m}}}^{2} {γ}_{m} {r}_{{α}_{m}} cos ( {P}_{m} ) & i {ρ}_{m} {c}^{2} {γ}_{m} ( {γ}_{m} - 1 ) sin ( {Q}_{m} ) & - {ρ}_{m} {c}^{2} {γ}_{m} ( {γ}_{m} - 1 ) sin ( {Q}_{m} )\end{matrix} ] , \qquad ( 5 )$$

where γₘ=2(Vsₘ/c)², Pₘ=kr_{α}_{ₘ} dₘ, [symbol] ₘ=kr_{β}_{ₘ} dₘ, the wave-number of k=ω/c, the parameters of dₘ and ρₘ are the thickness and density of the m^{th} layer, respectively. The elements of transitive matrix

Fₘ=DₘEₘ⁻¹ for the top and bottom interface eigenvalues of the m^{th} layer can be calculated from Eq. (3). Then, by incorporating the transitivity of the eigenvalues between layers, the media infinity radiation

$$( {B}_{m}^{″} = {C}_{m}^{″} = 0 ) ,$$

and the displacement and stress conditions required at the fluid-solid coupling interface:

$$\{ \begin{matrix}{w}_{0}^{-} = {w}_{0}^{+} \\ {σ}_{0}^{-} = {σ}_{0}^{+} \\ {τ}_{0}^{+} = 0\end{matrix} , \qquad ( 6 )$$

The dispersion equation of Scholte wave under horizontally layered media may be established as the following form:

$$( N \cdot K - M \cdot L ) + T ( G \cdot N - L \cdot H ) = 0 , \qquad ( 7 )$$

Where

$${σ}_{0}^{-} and {w}_{0}^{-}$$

denote the normal stress and vertical displacement at the bottom interface of seawater (the 0^{th}) layer,

$${σ}_{0}^{+} , {τ}_{0}^{+} and {w}_{0}^{+}$$

denote the normal and tangential stresses and vertical displacement at the top interface of the shallowest seabed (the 1^{th}) layer, respectively, the specific expressions of coefficients (G, H, L, M, N, K, T) are as follows:

$$\{ \begin{matrix}G = {r}_{n} {r}_{{α}_{n}} {F}_{13} + ( {r}_{n} - 1 ) {F}_{23} - {r}_{{α}_{n}} {F}_{33} / ( {ρ}_{n} {c}^{2} ) + {F}_{43} / ( {ρ}_{n} {c}^{2} ) \\ H = - ( {r}_{n} - 1 ) {F}_{13} + {r}_{n} {r}_{{β}_{n}} {F}_{23} + {F}_{33} / ( {ρ}_{n} {c}^{2} ) + {r}_{{β}_{n}} {F}_{43} / ( {ρ}_{n} {c}^{2} ) \\ L = {r}_{n} {r}_{{α}_{n}} {F}_{11} + ( {r}_{n} - 1 ) {F}_{21} - {r}_{{α}_{n}} {F}_{31} / ( {ρ}_{n} {c}^{2} ) + {F}_{41} / ( {ρ}_{n} {c}^{2} ) \\ M = - ( {r}_{n} - 1 ) {F}_{12} + {r}_{n} {r}_{{β}_{n}} {F}_{22} + {F}_{32} / ( {ρ}_{n} {c}^{2} ) + {r}_{{β}_{n}} {F}_{42} / ( {ρ}_{n} {c}^{2} ) \\ N = - ( {r}_{n} - 1 ) {F}_{11} + {r}_{n} {r}_{{β}_{n}} {F}_{21} + {F}_{31} / ( {ρ}_{n} {c}^{2} ) + {r}_{{β}_{n}} {F}_{41} / ( {ρ}_{n} {c}^{2} ) \\ K = {r}_{n} {r}_{{α}_{n}} {F}_{12} + ( {r}_{n} - 1 ) {F}_{22} - {r}_{{α}_{n}} {F}_{32} / ( {ρ}_{n} {c}^{2} ) + {F}_{42} / ( {ρ}_{n} {c}^{2} ) \\ T = ( {ρ}_{0} {c}^{2} / {r}_{{α}_{0}} ) tan ( {kr}_{{α}_{0}} {d}_{0} )\end{matrix} , \qquad ( 8 )$$

Where the transitive matrix F=Fₙ₋₁Fₙ₋₂ . . . Fₘ . . . F₁, the variables with subscripts of ‘0’ and ‘n’ represent the physical quantities of the water-layer and semi-infinite space, γₙ=2(Vsₙ/c)².

When dealing with the inviscid fluid layers situation or considering only the guided-wave modes closely related to P-wave, such as the marine Guided-P wave, the influences of parameters including S-wave velocity and shear modulus on the plane wave propagation may be neglected

$$( {C}_{m}^{′} = {C}_{m}^{″} = 0 ) .$$

However, in the process of deriving dispersion equation with the transitive matrix method, if the S-wave velocity or shear modulus is directly set to zero, the matrix Eₘ in Eq. (4) will become singular, i.e., Eₘ⁻¹ does not exist. We thus intend to seek a solution based on the transformation formulas (Eq. (9)) between the interface eigenvalues and potential function coefficients for this scenario:

$$\{ \begin{matrix}{u}_{m - 1} / c = - {( {V}_{{p}_{m}} / c )}^{2} ( {B}_{m}^{′} + {B}_{m}^{″} ) \\ {w}_{m - 1} / c = - {( {V}_{{p}_{m}} / c )}^{2} {r}_{am} ( {B}_{m}^{′} - {B}_{m}^{″} ) \\ {σ}_{m - 1} = {ρ}_{m} {V}_{{p}_{m}}^{2} ( {B}_{m}^{′} + {B}_{m}^{″} ) \\ {τ}_{m - 1} = 0\end{matrix} , \qquad ( 9 )$$

Where the variable of rₐₘ is associated to the P-wave velocity of the m^{th} layer (Vₚₘ) and can be calculated by the following formula:

$${r}_{am} = \{ \begin{matrix}+ {[ {( c / {V}_{{p}_{m}} )}^{2} - 1 ]}^{1 / 2} , & c > {V}_{{p}_{m}} \\ - {i [ 1 - {( c / {V}_{{p}_{m}} )}^{2} ]}^{1 / 2} , & c < {V}_{{p}_{m}}\end{matrix} . \qquad ( 10 )$$

Since the continuity of tangential displacement at interface is not a required condition under ideal fluid or acoustic mode assumption, Eq. (9) may be represented as follows:

$$\{ \begin{matrix}{B}_{m}^{′} + {B}_{m}^{″} = {σ}_{m - 1} / {ρ}_{m} {V}_{{p}_{m}}^{2} \\ {B}_{m}^{′} - {B}_{m}^{″} = - {( c / {V}_{{p}_{m}} )}^{2} {r}_{{a}_{m}}^{- 1} {w}_{m - 1} / c\end{matrix} ⇒ [ \begin{matrix}{B}_{m}^{′} + {B}_{m}^{″} \\ {B}_{m}^{′} - {B}_{m}^{″} \\ 0 \\ 0\end{matrix} ] = {E}_{Pm}^{- 1} [ \begin{matrix}{u}_{m - 1} \\ {w}_{m - 1} \\ {σ}_{m - 1} \\ 0\end{matrix} ] , \qquad ( 11 )$$

Where the matrices with subscript of P are corresponding to Guided-P wave. From Eq. (11), the inverse matrix of EPm may be easily represented as:

$${E}_{Pm}^{- 1} = [ \begin{matrix}0 & 0 & {( {ρ}_{m} {V}_{{p}_{m}}^{2} )}^{- 1} & 0 \\ 0 & - {( c / {V}_{{p}_{m}} )}^{2} {r}_{am}^{- 1} & 0 & 0 \\ 0 & 0 & 0 & 0 \\ 0 & 0 & 0 & 0\end{matrix} ] . \qquad ( 12 )$$

According to the expression of matrix Dₘ in Eq. (5), the matrix of D_{Pm} that is associated to P-wave can be written as:

$${D}_{Pm} = [ \begin{matrix}- {( {V}_{{P}_{m}} / c )}^{2} cos ( {\overline{P}}_{m} ) & {i ( {V}_{{P}_{m}} / c )}^{2} sin ( {\overline{P}}_{m} ) & 0 & 0 \\ {i ( {V}_{{P}_{m}} / c )}^{2} {r}_{am} sin ( {\overline{P}}_{m} ) & - {( {V}_{{P}_{m}} / c )}^{2} {r}_{am} cos ( {\overline{P}}_{m} ) & 0 & 0 \\ {ρ}_{m} {V}_{{p}_{m}}^{2} cos ( {\overline{P}}_{m} ) & - i {ρ}_{m} {V}_{{p}_{m}}^{2} sin ( {\overline{P}}_{m} ) & 0 & 0 \\ 0 & 0 & 0 & 0\end{matrix} ] , \qquad ( 13 )$$

Where the variable of P̅ₘ=krαmdm.

Analogous to the form in Eq. (3), the transitive matrix (F_{Pm}=D_{Pm}E_{Pm}⁻¹) for the eigenvalues at the top and bottom interfaces of the m^{th} layer can be yielded as follows:

$${F}_{Pm} = [ \begin{matrix}0 & - {ir}_{am}^{- 1} sin ( {\overline{P}}_{m} ) & - {( {ρ}_{m} {c}^{2} )}^{- 1} cos ( {\overline{P}}_{m} ) & 0 \\ 0 & cos ( {\overline{P}}_{m} ) & {{ir}_{am} ( {ρ}_{m} {c}^{2} )}^{- 1} sin ( {\overline{P}}_{m} ) & 0 \\ 0 & i {ρ}_{m} {c}^{2} {r}_{am}^{- 1} sin ( {\overline{P}}_{m} ) & cos ( {\overline{P}}_{m} ) & 0 \\ 0 & 0 & 0 & 0\end{matrix} ] . \qquad ( 14 )$$

And then the linear relationship between the top and bottom interface values can be easily established by the transitive matrix. Since the boundary continuity requires that the eigenvalues at the top interface of the m^{th} layer should be the same as that at the bottom interface of the (m−1)^{th} layer (i.e. the transitivity between adjacent layers), the transitive form of the eigenvalues for the whole multi-layer may be represented as:

$$[ \begin{matrix}{u}_{n - 1} \\ {w}_{n - 1} \\ {σ}_{n - 1} \\ 0\end{matrix} ] = {F}_{Pn - 1} [ \begin{matrix}{u}_{n - 2} \\ {w}_{n - 2} \\ {σ}_{n - 2} \\ 0\end{matrix} ] = {F}_{Pn - 1} {F}_{Pn - 1} … {F}_{Pm} … {F}_{P 1} [ \begin{matrix}{u}_{0} \\ {w}_{0} \\ {σ}_{0} \\ 0\end{matrix} ] , \qquad ( 15 )$$

Substituting the expression of the nth layer (the semi-infinite space) in Eq. (11) into Eq. (15), it can be gained the following linear relationship:

$$[ \begin{matrix}{B}_{n}^{′} + {B}_{n}^{″} \\ {B}_{n}^{′} - {B}_{n}^{″} \\ 0 \\ 0\end{matrix} ] = A [ \begin{matrix}{u}_{0} \\ {w}_{0} \\ {σ}_{0} \\ 0\end{matrix} ] , \qquad ( 16 )$$

Where the subscript of 0 indicates the top interface of seawater layer, the matrix of A=EPn−1FP=EPn−1FPn−1FPn−2 . . . FP1, which has the following expression:

$$A = [ \begin{matrix}\frac{{F}_{P 31}}{{ρ}_{n} {V}_{Pn}^{2}} & \frac{{F}_{P 32}}{{ρ}_{n} {V}_{Pn}^{2}} & \frac{{F}_{P 33}}{{ρ}_{n} {V}_{Pn}^{2}} & \frac{{F}_{P 34}}{{ρ}_{n} {V}_{Pn}^{2}} \\ \frac{- {( c / {V}_{Pn} )}^{2} {F}_{P 21}}{{r}_{α n}} & \frac{- {( c / {V}_{Pn} )}^{2} {F}_{P 22}}{{r}_{α n}} & \frac{- {( c / {V}_{Pn} )}^{2} {F}_{P 23}}{{r}_{α n}} & \frac{- {( c / {V}_{Pn} )}^{2} {F}_{P 24}}{{r}_{α n}} \\ 0 & 0 & 0 & 0 \\ 0 & 0 & 0 & 0\end{matrix} ] , \qquad ( 17 )$$

Considering the media infinity radiation (B″ₙ=0) and the sea surface free boundary (σ0=0) conditions, Eq. (16) can be written as:

$$\{ \begin{matrix}{B}_{n}^{′} = {A}_{11} {u}_{0} + {A}_{12} {w}_{0} \\ {B}_{n}^{′} = {A}_{21} {u}_{0} + {A}_{22} {w}_{0}\end{matrix} , \qquad ( 18 )$$

And the above can be converted to the form in Eq. (19) through merging the similar item:

$$( {A}_{11} - {A}_{21} ) {u}_{0} = ( {A}_{22} - {A}_{12} ) {w}_{0} , \qquad ( 19 )$$

Upon analysis, it can be found that the first column elements of the transitive matrix of F_{Pm} are all zeros, meaning that the first column elements of the matrix of A obtained by multiplying the transitive matrix of each layer are also zeros, i.e., A₂₁=A₁₁=0. Considered that the vertical displacement (w₀) is nonzero and the variables of A₁₂ and A₂₂ have different nonzero values, Eq. (19) may be rewritten as:

$${A}_{22} - {A}_{12} = 0. \qquad ( 20 )$$

Since the variables in Eq. (20) are the functions of parameters including frequency (ω), phase velocity (c), P-wave velocity (VP), thickness (d) and density (ρ), Eq. (20) is just a desired form for the dispersion equation of marine Guided-P wave. Therefore, the theoretical dispersion curves of Guided-P wave can be gained by solving the real-valued roots at different frequencies of this equation for a given model using some non-linear function iterative algorithms. Moreover, this method is more convenient and efficient than the existing iterative algorithm in complex domain based on surface wave secular function to calculate the theoretical dispersion curves of Guided-P wave. Notably, this equation is applicable to the situation of plane waves propagating in the media with high Poisson's ratio, such as Guided-P wave in shallow sea environment. The scheme validity tests are as follows:

### 1. Model Data Test

To verify the effectiveness of this invented technique, model data is firstly used for testing.

TABLE 1

| | Density | V_{P} | V_{S} | Thickness |
|---|---|---|---|---|
| Sequence | (kg/m³) | (m/s) | (m/s) | (m) |
| Seawater layer | 1000 | 1500 | 0 | 20 |
| Solid layer1 | 1500 | 1700 | 400 | 40 |
| Solid layer2 | 1800 | 2300 | 600 | 100 |
| Solid layer3 | 2000 | 3000 | 800 | ∞ |

Table 1 displays a shallow sea layered media model designed by the investigation results of actual seabed shallow media.

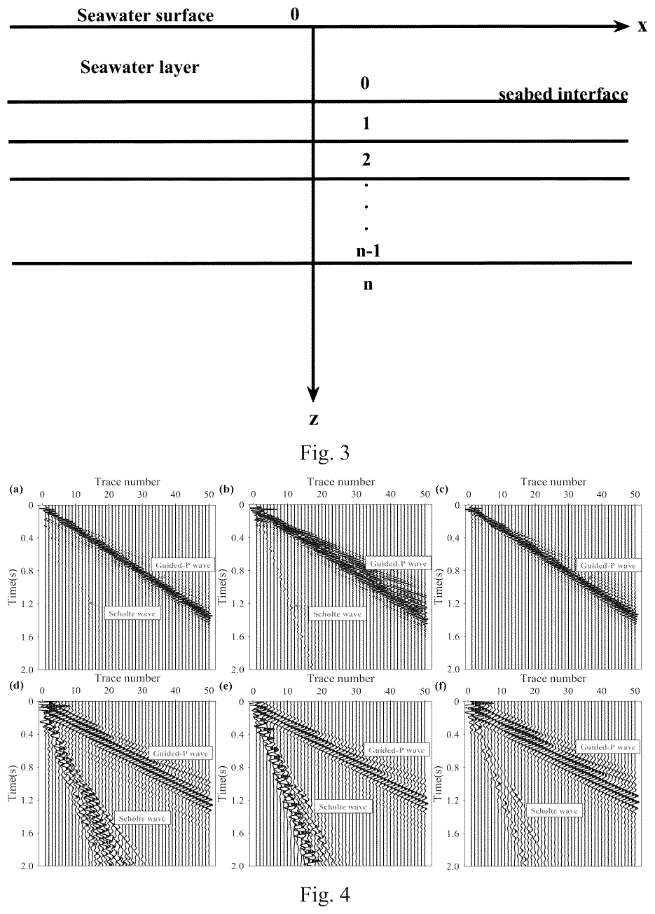

FIG. 4 shows the synthetic Guided-P and Scholte wave seismic records based on the model parameters in Table 1. In which, (a)(d), (b)(e) and (c)(f) represent the horizontal (X), vertical (Z) and pressure (P) components, respectively, (d)(e)(f) are the seismic records after the low-pass (<20 Hz) filtering.

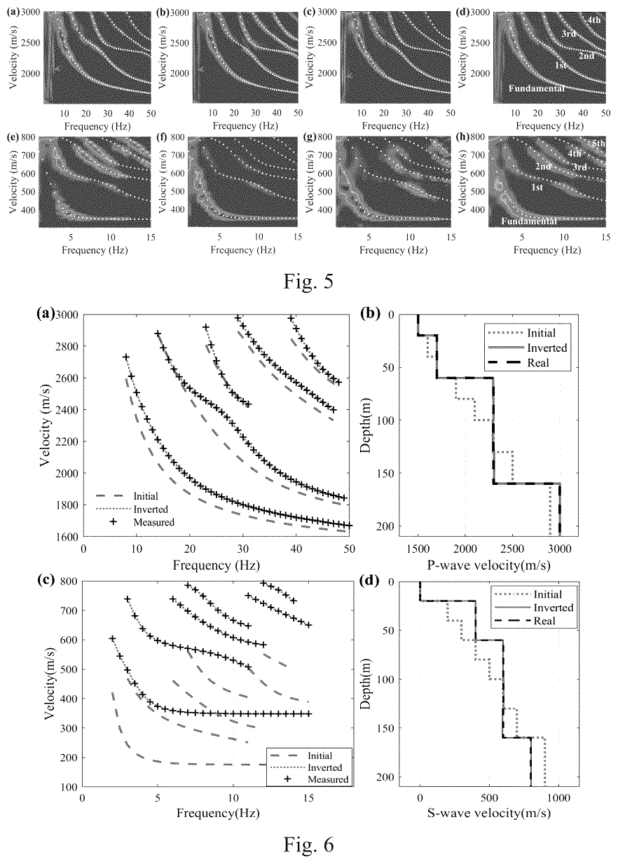

FIG. 5 shows the dispersion images of synthetic Guided-P (a-d) and Scholte (e-h) wave seismic records in the corresponding frequency and velocity ranges. In which, (a)(e), (b)(f) and (c)(g) represent the X, Z and P components, respectively, (d) and (h) represent the 3C stacking dispersion images of Guided-P and Scholte waves, respectively. It corresponds to step S02, that is, using the high resolution linear Radon transform (HLRT) method to conduct the multichannel dispersion analyses on the synthetic seismic records and generated their dispersion images in f-v domain.

In FIGS. 4 and 5, some characteristics can be summarized as follows: 1) Guided-P and Scholte waves exhibit the similar dispersive waveform in seismogram, but their lateral propagation distances differ significantly within the same observation time, due to the great velocity difference. And 2) Because the source sinking depth is shallow during forward modeling (i.e., the vertical distance between the source and seabed interface), Scholte wave possesses a weaker wave-field energy and a lower observable frequency band than Guided-P wave. The dispersion energy of Guided-P waves on X, Z and P components are obviously different, i.e., the fundamental mode has a wider observation frequency ranges on the X (8-50 Hz) and P (9-50 Hz) components than on the Z (7-27 Hz) component, but is notably affected by the low-frequency leaky mode on the X component. The dispersion energy of the higher modes is prominent on the Z component, especially the third and fourth higher modes. In contrast, the fundamental mode of Scholte wave is dominated on the Z component, whereas the higher modes are prominent on the X component.

It can be seen from the 3C stacking dispersion images that no matter Guided-P wave or Scholte wave, the combination of multiple components can be used to extract more abundant and detailed multi-order dispersion curves than that utilizing a single component. Furthermore, the multimodal dispersion energy peaks of Guided-P and Scholte waves in dispersion images match perfectly with the theoretical dispersion curves (as depicted with the white dotted lines), indicating the validity of the equation originally derived in step S05. After the dispersion imaging, the measured multi-order dispersion curves of Guided-P and Scholte waves can be gained via picking out the dispersion points corresponding to the energy peak in the 3C stacking dispersion images (Step S03).

Further referring to FIG. 6, which shows the dispersion inversion results of synthetic Guided-P and Scholte wave records. FIGS. 6(a) and (c) depict the fitting of dispersion curves of Guided-P and Scholte waves, respectively, where the lines with a symbol of ‘+’ represent the measured dispersion curves, the dashed lines symbolled as ‘- -’ represent the theoretical dispersion curve for the initial model, and the dotted lines represent the theoretical dispersion curve for the inverted model. FIGS. 6(b) and (d) depict the inversion results of 1D V_{P} and V_{S}, where the dashed lines symbolled as ‘- -’, the dotted lines and the lines with the symbol of ‘+’ represent the initial, inverted and true models, respectively.

FIG. 6 visually illustrates the specific implementation of the technical system (steps S04-S11) established in this invention, that is, the P-wave and S-wave velocities of seabed shallow media are retrieved through the inversions of multi-order dispersion curves of Guided-P and Scholte waves. As it shown, the inverted P-wave and S-wave velocities via the two wave dispersion inversions are consistent with the real values, which can indicate the effectiveness of the presented embodiment method.

### 2. Field Data Test

To verify the practicability of this embodiment method, field OBN seismic data is used to make some supplements based on the model data testing. FIG. 7 shows the field 4C-OBN common receiver point gathers acquired in a shallow sea (with the water-depth of 17 m) region in China, in which, (a), (b), (c) and (d) represent the R, T, Z and P components, respectively. Considering that both Guided-P and Scholte waves have weak wave-field energy on the horizontal tangential (T) component, the dispersion analyses of the two waves are only carried out by combining the R, Z and P components.

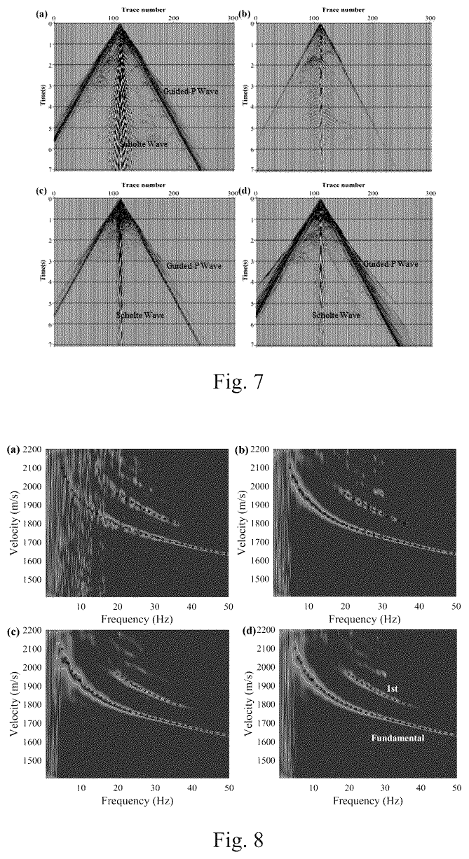

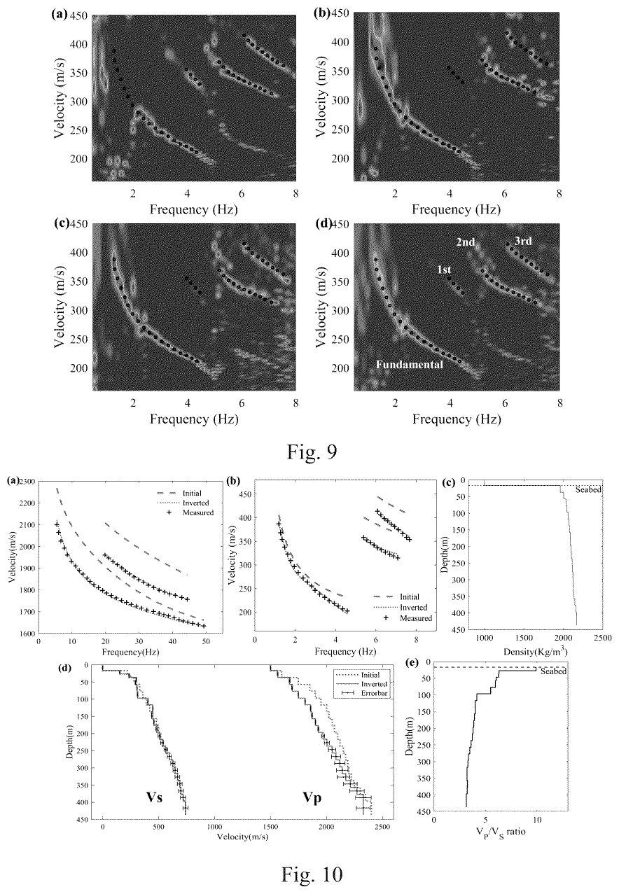

FIGS. 8 and 9 show the dispersion images of field Guided-P and Scholte wave seismic records in the corresponding frequency and velocity ranges. In which, (a), (b) and (c) represent the R, Z and P components, (d) represent the 3C stacking dispersion image. It is evident that the 3C stacking dispersion image exhibits a better energy cluster continuity and a wider observable frequency band range for each dispersion mode than the single component dispersion image. With regard to Guided-P wave, the dispersion curves of the fundamental and the first higher modes can be extracted within the velocity range of 1600-2200 m/s and the frequency range of 5-50 Hz, as illustrated in the black dot lines in FIG. 8. With regard to Scholte wave, the dispersion curves of the fundamental and the first to third higher modes can be extracted within the velocity range of 200-450 m/s and the frequency range of 1-8 Hz, as illustrated in the black dot lines in FIG. 9. Notably, the first higher mode of Scholte wave exhibits a lower-resolution dispersion energy and a narrower observable frequency band (FIG. 9d). To avoid the errors caused by these factors, it is more appropriate to jointly utilize the fundamental mode along with the second and third higher modes in the dispersion inversion of Scholte wave. The aforementioned contents are corresponding to the steps S02 to S03.

FIG. 10 shows the dispersion inversion results of field Guided-P and Scholte wave seismic data, that is, the implements of steps S04 to S11 on field data seismic. FIGS. 10(a) and (b) denote the dispersion curves fitting of Guided-P and Scholte waves, respectively, FIG. 10(c) denotes the densities at different depths, FIG. 10(d) denotes the inversion results of 1D V_{P} and V_{S} of seabed shallow media, in which the dashed lines symbolled as ‘- -’ denote the initial model, and the dotted lines denote the inverted model, and the black error bars denote the standard deviations, FIG. 10(e) denotes the retrieved V_{P}/V_{S} ratios at different depths, and the black horizontally dashed line denotes the seabed interface. As shown in FIG. 10, it can be found that both the inverted V_{P} and V_{S} increase with the depth, and range from 1560-2330 m/s and 160-740 m/s, respectively, which accords with the velocity features of seabed shallow media in shallow sea environment. The V_{P}/V_{S} ratio within a depth range of 10 m below the seabed interface is close to 9.8 (i.e., the Poisson's ratio is close to 0.49), which can be related to the fact that the shallow sediments in study sit are composed of silt with a poor consolidation and a high water-content. As the depth increases, the V_{P}/V_{S} ratio obviously decreases to between 5.5 and 6.0. This phenomenon can be explained incorporating the inversion results of Vs that the consolidation and shear strength of deeper layer are significantly stronger than that of the shallow silt layer.

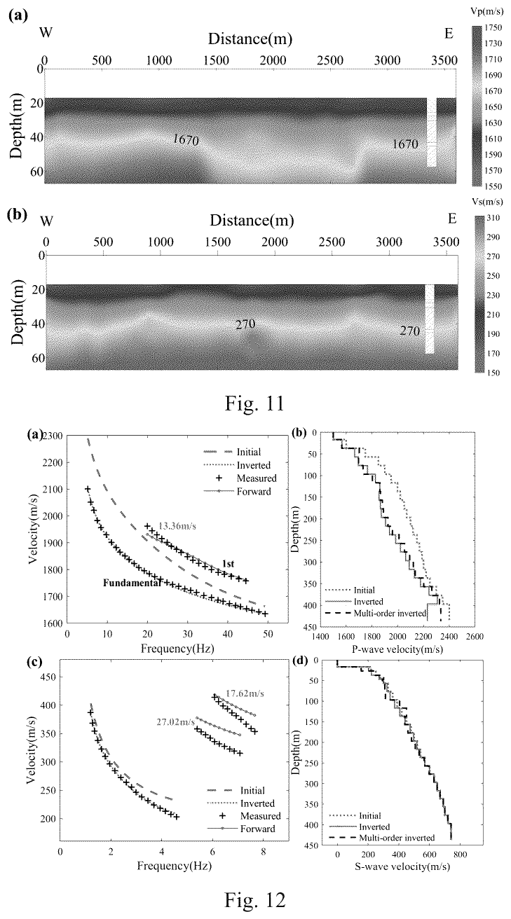

FIG. 11 shows the 2D pseudo profiles of V_{P} (a) and V_{S} (b) of seabed shallow media 50 m below the seabed interface. Specifically, it depicts the tomography imaging results of P-wave and S-wave velocity structures for seabed shallow media in this study site based on the available datasets, in which the borehole lithology column is embedded in the profiles for a comparison. It is visual that the seabed velocity structures obtained by the presented invention technique are basically consistent with the borehole results. That is, the low-velocity layer within the depth range of 10 m below the seabed interface corresponds to the unconsolidated muddy and silt layer, the depth range of 10-30 m corresponds to the moderately compact, plastic silty clay and fine sand layer, and the depth range below 30 m corresponds to moderately compact to dense, plastic silty sand and silty clay layer. The above results can indicate this invention has the practical applicability.

Furthermore, FIG. 12 shows the comparison of dispersion inversion results for both Guided-P and Scholte waves using the two methods of the single-component fundamental mode inversion and the joint inversion of fundamental and higher modes on multi-component. FIGS. 12(a) and (c) show the dispersion curves fitting situations for the dispersion inversion only using the fundamental mode. FIGS. 12(b) and (d) show the inversion results of 1D V_{P} and V_{S} by only using the fundamental mode (the solid lines) and jointly using the multi-mode (the dashed lines). In FIG. 12, it is visual that (i) the velocity models obtained from the two methods exhibit a similar trend with depth, but exhibit some numerical discrepancies; (ii) for both Guided-P and Scholte waves, the theoretical dispersion curves of the higher modes calculated by the velocity models yielded by the fundamental mode inversion (as indicated by the lines marked with dots) are obviously deviated from the measured dispersion curves (as indicated by the lines symbolled as ‘+’), which can illustrate the low accuracy of inversion model. To sum up, it could be drawn that jointly using the fundamental and higher-order dispersion curves on multi-component contributes to improve the inversion accuracy for the tomography imaging of velocity structures for seabed shallow media with Guided-P and Scholte waves.

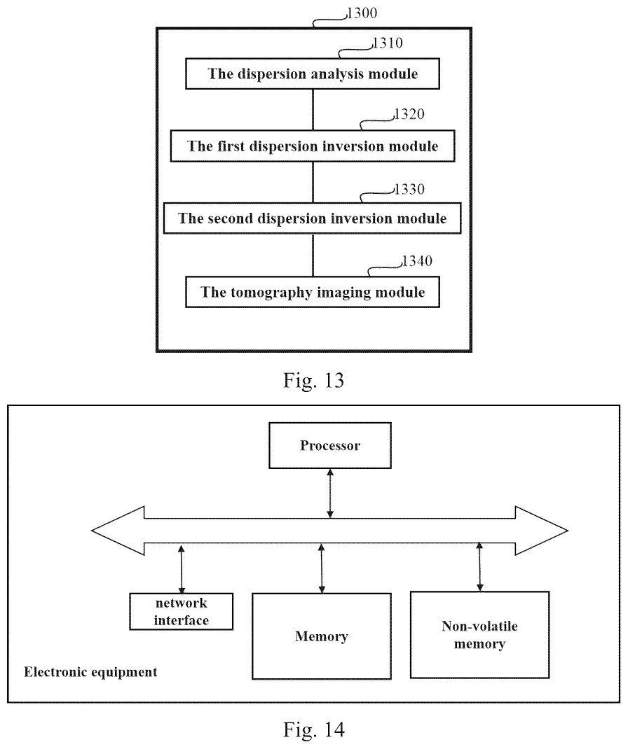

Additionally, corresponding to the method depicted in FIG. 1, another embodiment of the present disclosure provides a device for the tomography imaging of velocity structures for seabed shallow media. FIG. 13 shows a schematic diagram of the structure for the device, including a dispersion analysis module 1310, a first dispersion inversion module 1320, a second dispersion inversion module 1330 and a tomography imaging module 1340.

The dispersion analysis module 1310, is configured to configured to perform multichannel dispersion analyses of Guided-P and Scholte waves on seabed multi-component seismic gathers to determine measured multi-order dispersion curves of Guided-P and Scholte waves within corresponding frequency and velocity ranges.

The first dispersion inversion module 1320 is configured to configured to perform, based on a first seabed shallow media model for Guided-P wave dispersion inversion and a theoretical dispersion equation of Guided-P wave, joint inversion of the measured multi-order dispersion curves of Guided-P wave to iteratively update a model P-wave velocity, until a relative difference between measured and theoretical multi-order dispersion curves of Guided-P wave meets a first termination condition.

The second dispersion inversion module 1330 is configured to perform, based on a second seabed shallow media model for Scholte wave dispersion inversion and a theoretical dispersion equation of Scholte wave, joint inversion of measured multi-order dispersion curves of Scholte wave to iteratively update a model S-wave velocity under the constraint of the P-wave velocity determined by Guided-P wave dispersion inversion, until a relative difference between measured and theoretical multi-order dispersion curves of Scholte wave meets a second termination condition.

The tomography imaging module 1340 is configured to perform, based on the P-wave and S-wave velocities respectively determined by Guided-P and Scholte wave dispersion inversions, tomography imaging of velocity structures for the seabed shallow media.

Optionally, the first dispersion inversion module 1320, performs, based on the first seabed shallow media model for Guided-P wave dispersion inversion and the theoretical dispersion equation of Guided-P wave, joint inversion of the measured multi-order dispersion curves of Guided-P wave to iteratively update the P-wave velocity, until the relative difference between the measured and theoretical multi-order dispersion curves of Guided-P wave meets the first termination condition, includes: the first seabed shallow media model for the Guided-P wave dispersion inversion is constructed based on the half-wavelength theory and empirical formulas of seabed shallow media. This model consists of multiple equi-thickness thin layers and a semi-infinite space beneath them. The maximum total depth of model is determined by the maximum phase velocity and minimum frequency in the measured multi-mode dispersion curves of P-waves. The initial P-wave velocity and density of each layer are determined by the empirical relationships, and the density values remain constant during the iterative calculations for Guided-P wave dispersion inversion.

Based on physical parameters (including P-wave velocity, thickness and density) of each the equi-thickness thin layer and the semi-infinite space of the first seabed shallow media model, the theoretical multi-order dispersion curves of Guided-P wave phase velocities for this model are calculated by solving the theoretical dispersion equation of Guided-P wave.

Based on the first objective function, the corrected values of the P-wave velocities of all equi-thickness thin layers and the semi-infinite space in the first seabed shallow media model are iteratively calculated, and the P-wave velocity of each layer is adjusted according to the corrected values obtained from each iteration.

Where, the first objective function is expressed as:

$${Φ}_{P} = {‖ {J}_{P} Δ {V}_{P} - Δ {b}_{P} ‖}_{2}^{2} W {‖ {J}_{P} Δ {V}_{P} - Δ {b}_{P} ‖}_{2} + α {‖ Δ {V}_{P} ‖}_{2}^{2} ,$$

where J_{P} denotes the Jacobi matrix composed of the first-order partial derivatives of Guided-P wave phase velocity to P-wave velocity, ΔVp denotes the corrected values of P-wave velocity, Δbₚ denotes the relative difference between the measured and theoretical multi-order dispersion curves of Guided-P wave, α denotes the damping coefficient, and W denotes the weighting matrix.

Based on the each layer parameters of the iteratively updated model, the theoretical multi-order dispersion curves of Guided-P wave are calculated.

Optionally, the described relative difference between the measured and theoretical multi-order dispersion curves of Guided-P wave has the following expression:

$$rms ( dvp ) = \sqrt{1 / {N}_{1} {\sum }_{i = 1}^{{N}_{1}} {( \frac{Δ {b}_{Pi}}{{b}_{pi}^{obs}} )}^{2}}$$

where N₁ denotes the total of multi-order dispersion points for Guided-P wave.

The first termination condition is that the relative difference between the measured and theoretical multi-order dispersion curves of Guided-P wave is less than the allowable error tolerance.

Optionally, the first dispersion inversion module 1320 can be used to calculate the theoretical multi-order dispersion curves of Guided-P wave for the first seabed shallow media model by solving the real-valued roots of Guided-P wave dispersion equation. This includes establishing a marine Guided-P wave dispersion equation related to plane wave phase velocity, frequency, P-wave velocity and thickness; and calculating the real-valued roots of this equation at different frequencies for the first seabed shallow media model through any one of the dichotomies, Muller or Newton-Raphson methods.

Optionally, the second dispersion inversion module 1330 based on the second seabed shallow media model and the theoretical dispersion equation of Scholte wave, performs joint inversion of measured multi-order dispersion curves of Scholte wave to iteratively update the model S-wave velocity under the constraint of the P-wave velocity determined by the Guided-P wave dispersion inversion, until the relative difference between the measured and theoretical multi-order dispersion curves of Scholte wave meets the second termination condition, includes: based on the half-wavelength theory and empirical formulas of seabed shallow media, the second seabed shallow media model for Scholte wave dispersion inversion is constructed. The second seabed shallow media model includes multiple equi-thickness thin layers and a semi-infinite space that are identical to those in the first seabed shallow media model. The each layer P-wave velocity for this model is adopted the one determined by Guided-P wave dispersion inversion and remains fixed, the initial S-wave velocity of each solid layer is determined by the P-wave velocity and the empirical Vp/Vs ratio of seabed shallow media, and the thickness and density parameters are consistent with those in the first seabed shallow media model.

Based on the physical parameters of each equi-thickness thin layer and semi-infinite space in the second seabed shallow media model, the theoretical multi-order dispersion curves of Scholte wave phase velocities are calculated by solving fluid-solid interface wave dispersion equation.

And, based on the second objective function, the corrected values of the S-wave velocities for each thin layer and semi-infinite space in the second seabed shallow media model are iteratively updated, and the S-wave velocities of each equi-thickness layer and semi-infinite space is adjusted according to the corrected values from each iteration.

The second objective function is expressed as:

$${Φ}_{S} = {‖ {J}_{S} Δ {V}_{S} - Δ {b}_{S} ‖}_{2}^{2} W {‖ {J}_{S} Δ {V}_{S} - Δ {b}_{S} ‖}_{2} + α {‖ Δ {V}_{S} ‖}_{2}^{2} ,$$

where J_{S} denotes the Jacobi matrix composed of the first-order partial derivatives of Scholte wave phase velocity to S-wave velocity, ΔVs denotes the corrected values of S-wave velocity, and Δbₛ denotes the relative difference between the measured and theoretical multi-order dispersion curves of Scholte wave.

Based on the layer parameters of the iteratively updated model, the theoretical multi-order dispersion curves of Scholte wave are calculated.

Optionally, the described relative difference between the measured and theoretical multi-order dispersion curves of Scholte wave has the following expression:

$$rms ( dvs ) = \sqrt{1 / {N}_{2} {\sum }_{i = 1}^{{N}_{2}} {( \frac{Δ {b}_{Si}}{{b}_{Si}^{obs}} )}^{2}} ,$$

where N₂ denotes the total of multi-order dispersion points for Scholte wave.

The second termination condition is that the relative difference between the measured and theoretical multi-order dispersion curves of Scholte wave is less than the allowable error tolerance.

Optionally, the tomography imaging module 1340 based on the P-wave and S-wave velocities respectively determined by Guided-P and Scholte wave dispersion inversions, performs tomography imaging of velocity structures for seabed shallow media includes: dispersion inversions of Guided-P and Scholte waves are performed in various seismic gathers along survey lines to gain the all 1D P-wave and S-wave velocity profiles; and these values are arranged and interpolated according to their respective lateral positions to perform the 2D tomography imaging of velocity structures for seabed shallow media.

It should be understood that the velocity tomography imaging device of this embodiment can serve as the main execution entity for the method shown in FIG. 1, and thus is capable of performing the steps and functions outlined in the method of FIG. 1.

FIG. 14 depicts a schematic diagram of the structure of an electronic equipment provided by an embodiment of the present disclosure. With reference to FIG. 14, at the hardware level, the electronic equipment includes a processor and may optionally include an internal bus, a network interface, and memory. The memory may comprise volatile memory, such as Random-Access Memory (RAM), as well as non-volatile memory, such as at least one disk storage device. Certainly, the electronic equipment may also include the hardware components required for other business disclosures.

The processor, network interface, and memory may be interconnected via the internal bus, which can be the Industry Standard Architecture (ISA) bus, the Peripheral Component Interconnect (PCI) bus, or the Extended Industry Standard Architecture (EISA) bus, among others. Said bus can be divided into address bus, data bus, control bus, etc. For the sake of representation, the internal bus is depicted by a single bidirectional arrow in FIG. 14, but this does not imply that there is only one bus or that it is of a single type.

The memory is used to store programs. Specifically, the programs may include program code, which consists of computer operation instructions. The memory can include both volatile memory and non-volatile memory, providing instructions and data to the processor.

The processor reads the corresponding computer program from the non-volatile memory into the volatile memory and then executes it, thereby forming the device of tomographic imaging of velocity structures for seabed shallow media at the logical level. The processor executes the programs stored in the memory and is specifically used to perform the following operations: performing multichannel dispersion analyses of Guided-P and Scholte waves on seabed multi-component seismic gathers to determine measured multi-order dispersion curves of Guided-P and Scholte waves within corresponding frequency and velocity ranges; performing, based on a first seabed shallow media model for Guided-P wave dispersion inversion and a theoretical dispersion equation of Guided-P wave, joint inversion of the measured multi-order dispersion curves of Guided-P wave to iteratively update a model P-wave velocity, until a relative difference between measured and theoretical multi-order dispersion curves of Guided-P wave meets a first termination condition; performing, based on a second seabed shallow media model for Scholte wave dispersion inversion and a theoretical dispersion equation of Scholte wave, joint inversion of measured multi-order dispersion curves of Scholte wave to iteratively update a model S-wave velocity under the constraint of the P-wave velocity determined by Guided-P wave dispersion inversion, until a relative difference between measured and theoretical multi-order dispersion curves of Scholte wave meets a second termination condition; and performing, based on the P-wave and S-wave velocities respectively determined by Guided-P and Scholte wave dispersion inversions, tomography imaging of velocity structures for seabed shallow media.

The method disclosed in the embodiment shown in FIG. 1 of this disclosure can be implemented in a processor or realized by the processor. The processor may be an integrated circuit chip with signal processing capabilities. During implementation, the steps of the aforementioned method can be carried out through integrated logic circuits in the processor hardware or through instructions in software form. The processor may be a general-purpose processor, including a Central Processing Unit (CPU), a Network Processor (NP), etc.; it may also be a Digital Signal Processor (DSP), an Application-Specific Integrated Circuit (ASIC), a Field-Programmable Gate Array (FPGA), or other programmable logic devices, discrete gates or transistor logic devices, or discrete hardware components. The methods, steps, and logic diagrams disclosed in one or more embodiments of this disclosure can be implemented or executed. A general-purpose processor may be a microprocessor or any conventional processor. The steps of the methods disclosed in one or more embodiments of this disclosure can be directly embodied in hardware decoding executed by the processor or accomplished through a combination of hardware and software modules within the processor. Software modules may reside in various well-established storage media, such as random-access memory (RAM), flash memory, read-only memory (ROM), programmable read-only memory (PROM), electrically erasable programmable memory (EEPROM), or registers. These storage media are part of the memory system, and the processor reads the information from the memory and completes the steps of the aforementioned methods in conjunction with its hardware.

Of course, the electronic equipment described in this disclosure does not exclude other implementation methods other than software implementations, such as logic devices or hybrid hardware-software approaches. In other words, the execution of the following processing flows is not limited to individual logic units but can also be carried out by hardware or logic devices.

An embodiment of this disclosure also provides a computer program product, which includes a computer-readable storage medium storing a computer program. The computer program is configured to cause a computer to perform the following operations: performing multichannel dispersion analyses of Guided-P and Scholte waves on seabed multi-component seismic gathers to determine measured multi-order dispersion curves of Guided-P and Scholte waves within corresponding frequency and velocity ranges; performing, based on a first seabed shallow media model for Guided-P wave dispersion inversion and a theoretical dispersion equation of Guided-P wave, joint inversion of the measured multi-order dispersion curves of Guided-P wave to iteratively update a model P-wave velocity, until a relative difference between measured and theoretical multi-order dispersion curves of Guided-P wave meets a first termination condition; performing, based on a second seabed shallow media model for Scholte wave dispersion inversion and a theoretical dispersion equation of Scholte wave, joint inversion of measured multi-order dispersion curves of Scholte wave to iteratively update a model S-wave velocity under the constraint of the P-wave velocity determined by Guided-P wave dispersion inversion, until a relative difference between measured and theoretical multi-order dispersion curves of Scholte wave meets a second termination condition; and performing, based on the P-wave and S-wave velocities respectively determined by Guided-P and Scholte wave dispersion inversions, tomography imaging of velocity structures for seabed shallow media.

In summary, the above description is merely preferred embodiments of this disclosure, and is not intended to limit the scope of protection of this disclosure. Any modification, equivalent substitution, or improvement made within the spirit and principles of one or more embodiments of this disclosure should be included within the scope of protection of one or more embodiments of this disclosure.

The systems, devices, modules, or units described in the above embodiments can be implemented specifically by computer chips or physical entities, or by products with specific functionalities. A typical implementation device is a computer. Specifically, the computer may be, for example, a personal computer, laptop, cellular phone, camera phone, smartphone, personal digital assistant, media player, navigation device, email device, game console, tablet computer, wearable device, or any combination of these devices.

Computer-readable media, including both permanent and non-permanent, removable and non-removable media that can be implemented by any method or technology for storing information. The information may include computer-readable instructions, data structures, modules of programs, or other data. Examples of computer storage media include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory or other memory technologies, compact discs read-only memory (CD-ROM), digital versatile discs (DVDs) or other optical storage, magnetic tape cartridges, magnetic disk storage or other magnetic storage devices, or any other non-transitory medium that can be used to store information accessible by a computing device. According to the definition provided herein, computer-readable media do not include transitory computer-readable media, such as modulated data signals and carrier waves.

It should also be noted that the terms “include,” “comprise,” or any variations thereof are intended to be non-exclusive inclusions, which means that processes, methods, products, or devices that include a certain set of elements are not limited to those elements alone but also encompass additional elements not expressly listed, or elements inherent to such processes, methods, products, or devices. Without further limitations, the element qualified by the phrase “including one . . . ” does not preclude the presence of additional identical elements in the process, method, product, or device that includes the said element.

Each embodiment in this disclosure is described in a stepwise manner. Similar and identical parts among the embodiments can be referred to each other, with each embodiment focusing on the differences from the others. In particular, since the system embodiment is basically similar to the method embodiment, the description is relatively simple, and reference may be made to the partial description of the method embodiment for related details.

What is claimed:

1. A method for velocity tomography imaging of seabed shallow media, characterized by comprising:
performing multichannel dispersion analyses of Guided-P and Scholte waves on seabed multi-component seismic gathers to determine measured multi-order dispersion curves of Guided-P and Scholte waves within corresponding frequency and velocity ranges;
performing, based on a first seabed shallow media model for Guided-P wave dispersion inversion and a theoretical dispersion equation of Guided-P wave, joint inversion of the measured multi-order dispersion curves of Guided-P wave to iteratively update a P-wave velocity, until a relative difference between measured and theoretical multi-order dispersion curves of Guided-P wave meets a first termination condition;
performing, based on a second seabed shallow media model for Scholte wave dispersion inversion and a theoretical dispersion equation of Scholte wave, joint inversion of measured multi-order dispersion curves of Scholte wave to iteratively update a S-wave velocity under the constraint of the P-wave velocity determined by Guided-P wave dispersion inversion, until a relative difference between measured and theoretical multi-order dispersion curves of Scholte wave meets a second termination condition; and
performing, based on the P-wave and S-wave velocities respectively determined by Guided-P and Scholte wave dispersion inversions, tomography imaging of velocity structures for the seabed shallow media.

2. The method according to claim 1, characterized in that performing, based on the first seabed shallow media model for Guided-P wave dispersion inversion and the theoretical dispersion equation of Guided-P wave, joint inversion of the measured multi-order dispersion curves of Guided-P wave to iteratively update the P-wave velocity, until the relative difference between the measured and theoretical multi-order dispersion curves of Guided-P wave meets the first termination condition, comprises:
constructing, based on a half-wavelength theory and empirical formulas of seabed shallow media, the first seabed shallow media model for Guided-P wave dispersion inversion; wherein the first seabed shallow media model is composed of multiple equi-thickness thin layers and one semi-infinite space, a maximum total thickness of the equi-thickness thin layers is determined by a maximum phase velocity and a minimum frequency of the measured multi-order dispersion curves of Guided-P wave, an initial P-wave velocity and density of each equi-thickness thin layer and the semi-infinite space are determined by the empirical formulas, and the density of each the equi-thickness thin layer remains fixed during iteration of Guided-P wave dispersion inversion;
calculating, based on physical parameters of each the equi-thickness thin layer and the semi-infinite space in the first seabed shallow media model, the theoretical multi-order dispersion curves of Guided-P wave phase velocities by solving the theoretical dispersion equation of Guided-P wave; and
iteratively updating, based on a first objective function, corrected values of the P-wave velocities for each the equi-thickness thin layer and semi-infinite space in the first seabed shallow media model, and adjusting the P-wave velocities of each equi-thickness layer and the semi-infinite space according to corrected values from each iteration;
wherein the first objective function is:
$${Φ}_{P} = {‖ {J}_{P} Δ {V}_{P} - Δ {b}_{P} ‖}_{2}^{2} W {‖ {J}_{P} Δ {V}_{P} - Δ {b}_{P} ‖}_{2} + α {‖ Δ {V}_{P} ‖}_{2}^{2} ,$$
wherein JP denotes a Jacobi matrix composed of first-order partial derivatives of Guided-P wave phase velocity to P-wave velocity, ΔVp denotes the corrected values of P-wave velocity, Δbp denotes the relative difference between the measured and theoretical multi-order dispersion curves of Guided-P wave, α denotes a damping coefficient, and W denotes a weighting matrix.

3. The method according to claim 1, characterized in that a formula for calculating the relative difference between the measured and theoretical multi-order dispersion curves of Guided-P wave is:
$$rms ( dvp ) = \sqrt{1 / {N}_{1} {\sum }_{i = 1}^{{N}_{1}} {( \frac{Δ {b}_{Pi}}{{b}_{pi}^{obs}} )}^{2}} ,$$
wherein N denotes a total of multi-order dispersion points for Guided-P wave; and the first termination condition comprises the relative difference between the measured and theoretical multi-order dispersion curves of Guided-P wave is less than or equal to a first allowable error tolerance.

4. The method according to claim 2, characterized in that calculating, based on physical parameters of each the equi-thickness thin layer and the semi-infinite space in the first seabed shallow media model, the theoretical multi-order dispersion curves of Guided-P wave phase velocities by solving the theoretical dispersion equation of Guided-P wave, comprises:
establishing the theoretical dispersion equation of Guided-P wave in marine environment related to plane wave phase velocity, frequency, P-wave velocity, density and thickness; and
calculating the theoretical multi-order dispersion curves of Guided-P wave phase velocity by using any of dichotomization, Muller or Newton-Raphson methods to solve real-valued roots at different frequencies of the theoretical dispersion equation of Guided-P wave with respect to the first seabed shallow media model.

5. The method according to claim 2, characterized in that performing, based on the second seabed shallow media model for Scholte wave dispersion inversion and the theoretical dispersion equation of Scholte wave, joint inversion of the measured multi-order dispersion curves of Scholte wave to iteratively update the S-wave velocity under the constraint of the P-wave velocity determined by Guided-P wave dispersion inversion, until the relative difference between the measured and theoretical multi-order dispersion curves of Scholte wave meets the second termination condition, comprises:
constructing, based on a half-wavelength theory and empirical formulas of seabed shallow media, the second seabed shallow media model for Scholte wave dispersion inversion; wherein the second seabed shallow media model comprises multiple equi-thickness thin layers and a semi-infinite space that are identical to those in the first seabed shallow media model, each layer for the second seabed shallow media model adopts the P-wave velocity determined by Guided-P wave dispersion inversion, an initial S-wave velocity of each layer is determined by the P-wave velocity and the empirical Vp/Vs ratio of seabed shallow media, and thickness and density parameters of each layer are consistent with those in the first seabed shallow media model respectively;
calculating, based on physical parameters of each the equi-thickness thin layer and semi-infinite space in the second seabed shallow media model, the theoretical multi-order dispersion curves of Scholte wave phase velocities by solving the theoretical dispersion equation of Scholte wave; and
iteratively updating, based on a second objective function, corrected values of the S-wave velocities for each the equi-thickness thin layer and semi-infinite space in the second seabed shallow media model, and adjusting the S-wave velocities of each the equi-thickness layer and semi-infinite space according to corrected values from each iteration;
wherein the second objective function is:
$${Φ}_{S} = {‖ {J}_{S} Δ {V}_{S} - Δ {b}_{S} ‖}_{2}^{2} W {‖ {J}_{S} Δ {V}_{S} - Δ {b}_{S} ‖}_{2} + α {‖ Δ {V}_{S} ‖}_{2}^{2} ,$$
wherein J_{S} denotes a Jacobi matrix composed of first-order partial derivatives of Scholte wave phase velocity to S-wave velocity, ΔVs denotes the corrected values of S-wave velocity, and Δbs denotes the relative difference between the measured and theoretical multi-order dispersion curves of Scholte wave.

6. The method according to claim 1, characterized in that a formula for calculating the relative difference between the measured and theoretical multi-order dispersion curves of Scholte wave is:
$$rms ( dvs ) = \sqrt{1 / {N}_{2} {\sum }_{i = 1}^{{N}_{2}} {( \frac{Δ {b}_{Si}}{{b}_{Si}^{obs}} )}^{2}} ,$$
wherein N denotes a total of multi-order dispersion points for Scholte wave; the second termination condition comprises the relative difference between the measured and theoretical multi-order dispersion curves of Scholte wave is less than or equal to a second allowable error tolerance.

7. The method according to claim 1, characterized in that performing, based on the P-wave and S-wave velocities respectively determined by Guided-P and Scholte wave dispersion inversions, tomography imaging of velocity structures for the seabed shallow media, comprises:
performing dispersion inversion of Guided-P and Scholte waves on different seismic gathers along a survey line to determine one-dimension (1D) P-wave and S-wave velocity profiles at various lateral positions, respectively; and
conducting two-dimension (2D) tomography imaging on the P-wave and S-wave velocity structures of shallow seabed media based on inversion results of the 1D P-wave and S-wave velocities at various lateral positions.

8. A device for velocity tomography imaging of seabed shallow media, characterized by comprising:
a dispersion analysis module, configured to perform multichannel dispersion analyses of Guided-P and Scholte waves on seabed multi-component seismic gathers to determine measured multi-order dispersion curves of Guided-P and Scholte waves within corresponding frequency and velocity ranges;
a first dispersion inversion module, configured to perform, based on a first seabed shallow media model for Guided-P wave dispersion inversion and a theoretical dispersion equation of Guided-P wave, joint inversion of the measured multi-order dispersion curves of Guided-P wave to iteratively update a model P-wave velocity, until a relative difference between measured and theoretical multi-order dispersion curves of Guided-P wave meets a first termination condition;
a second dispersion inversion module, configured to perform, based on a second seabed shallow media model for Scholte wave dispersion inversion and a theoretical dispersion equation of Scholte wave, joint inversion of measured multi-order dispersion curves of Scholte wave to iteratively update a model S-wave velocity under the constraint of the P-wave velocity determined by Guided-P wave dispersion inversion, until a relative difference between measured and theoretical multi-order dispersion curves of Scholte wave meets a second termination condition; and
a tomography imaging module, configured to perform, based on the P-wave and S-wave velocities respectively determined by Guided-P and Scholte wave dispersion inversions, tomography imaging of velocity structures for the seabed shallow media.

9. An electronic equipment, comprising a processor and a memory arranged to store computer executable instructions, when being executed, the executable instructions enable the processor to perform the method according to claim 1.

10. A computer program product, comprising a non-transitory computer-readable storage medium storing a computer program, wherein the computer program is operable to enable a computer to perform the method according to claim 1.

11. The method according to claim 2, characterized in that a formula for calculating the relative difference between the measured and theoretical multi-order dispersion curves of Guided-P wave is:
$$rms ( dvp ) = \sqrt{1 / {N}_{1} {\sum }_{i = 1}^{{N}_{1}} {( \frac{Δ {b}_{Pi}}{{b}_{pi}^{obs}} )}^{2}} ,$$
wherein N denotes a total of multi-order dispersion points for Guided-P wave; and the first termination condition comprises the relative difference between the measured and theoretical multi-order dispersion curves of Guided-P wave is less than or equal to a first allowable error tolerance.

12. The method according to claim 5, characterized in that a formula for calculating the relative difference between the measured and theoretical multi-order dispersion curves of Scholte wave is:
$$rms ( dvs ) = \sqrt{1 / {N}_{2} {\sum }_{i = 1}^{{N}_{2}} {( \frac{Δ {b}_{Si}}{{b}_{Si}^{obs}} )}^{2}} ,$$
wherein N denotes a total of multi-order dispersion points for Scholte wave; the second termination condition comprises the relative difference between the measured and theoretical multi-order dispersion curves of Scholte wave is less than or equal to a second allowable error tolerance.
